(19) United States
(12) Patent Application Publication
(10) Pub. No.: US 2013/0171370 A1
(43) Pub. Date: Jul. 4, 2013

(54) PROCESS AND SYSTEM FOR PRODUCING ELECTROCHEMICAL CELLS FOR ELECTROCHEMICAL STORAGE

(71) Applicant: Li-Tec Battery GmbH, Kamenz (DE)

(72) Inventors: Steffen Legner, Ellwangen (DE); Tim Schaefer, Harztor (DE)

(73) Assignee: Li-Tec Battery GmbH, Kamenz (DE)

(21) Appl. No.: 13/730,529

(22) Filed: Dec. 28, 2012

Related U.S. Application Data
(60) Provisional application No. 61/581,659, filed on Dec. 30, 2011.

(30) Foreign Application Priority Data
Dec. 30, 2011 (DE) 10 2011 122 658.7

(51) Int. Cl. H01M 2/14; H01M 4/04

(52) U.S. Cl. CPC H01M 2/145; H01M 4/04
USPC 427/535; 118/620

(57) ABSTRACT

A process is described for producing sheet- or plate-type objects, particularly for producing electrodes and/or separators for constructing an electrochemical energy storage, preferably designed for use in a motor vehicle, or for producing parts of such electrodes and/or such separators, wherein the sheet- or plate-type objects have a first object side surface and a second object side surface on the opposite side to the first object side surface. The production process includes the following steps: reducing (S5′) the electrostatic charge on the first object side surface of the sheet- or plate-type objects by applying a plasma, particularly an atmospheric plasma, to act on the first object side surface of the sheet- or plate-type objects, and reducing (S5″) the electrostatic charge on the second object side surface of the sheet- or plate-type objects by applying a plasma, particularly an atmospheric plasma, to act on the second object side surface of the sheet- or plate-type objects.

The present invention relates to a process and system for producing electrochemical cells for electrochemical energy storages, particularly a process and system for producing electrodes and/or separators for constructing an electrochemical energy storage or parts of such electrodes and/or such separators.

Known electrochemical energy storages include batteries (primary storages) and rechargeable batteries (secondary storages), which are constructed from one or more storage cells in which electrical energy is converted into chemical energy in an electrochemical charging reaction between a cathode and an anode in or between an electrolyte when a charge current is applied, and stored in this way, and in which chemical energy is converted into electrical energy in an electrochemical discharging reaction when an electrical consumer is connected. Primary storages are usually charged only once, and are disposed of after discharging, whereas secondary storages allow multiple (from a few hundred to over 10,000) charging and discharging cycles. In this context, it should be noted that accumulators are also referred to as batteries, particularly in the field of automotive technology.

Very large numbers of electrodes are needed, so there is a need for high-quality, effective and inexpensive production processes.

It is therefore an object of the present invention to provide an improved process and system for producing objects in the form of leaves or plates.

This object is solved with a process for producing sheet- or plate-type objects according to claim 1 and/or a system for producing sheet- or plate-type objects according to claim 12. Advantageous variations and embodiments are subject-matters of the dependent claims.

According to a first aspect, this object is solved for a process for producing sheet- or plate-type objects, particularly for producing electrodes and/or separators for constructing an electrochemical energy storage, preferably designed for use in a motor vehicle, or for producing parts of such electrodes and/or such separators, wherein the sheet- or plate-type objects have a first object side surface and a second object side surface on the opposite side to the first object side surface, in that the production process includes the following steps: reduction of the electrostatic charge on the first object side surface of the sheet- or plate-type objects by applying a plasma, particularly an atmospheric plasma to act on the first object side surface of the sheet- or plate-type objects, and reduction of the electrostatic charge on the second object side surface of the sheet- or plate-type objects by applying a plasma, particularly an atmospheric plasma to act on the second object side surface of the sheet- or plate-type objects. One advantage of this configuration consists in that an electrostatic charge of the electrodes and separators, which may occur particularly during processing steps on strip materials in dry rooms, and are capable of causing dielectric breakdowns in the separator during production of the electrochemical cells may be reduced or eliminated. With this variation, it is possible to improve the quality of the electrochemical cells. A further advantage of the process according to the invention consists in that it may easily be integrated in existing production plants.

For the purposes of the present document, an “electrochemical energy storage” is understood to refer to any kind of energy storage from which electrical energy can be drawn, wherein an electrochemical reaction takes place inside the energy storage. The term encompasses energy stores of all kinds, particularly primary batteries and secondary batteries. The electrochemical energy storage device has at least one electrochemical cell, preferably multiple electrochemical cells. The multiple electrochemical cells may be connected in parallel in order to store a larger charge, or in series to achieve a desired operating voltage, or they may be configured in a combination of parallel and series connections.

In this context, the term “electrochemical cell” is understood to mean a device that is used to deliver electrical energy, the energy being stored in chemical form. In the case of rechargeable, secondary batteries the cell is also designed so as to be able to take up electrical energy, convert such energy into chemical energy, and store it. The form (that is to say particularly the size and geometry) of an electrochemical cell may be selected according to the available space. The electrochemical cell is preferably essentially prismatic or cylindrical in shape. The present invention is particularly advantageously usable for electrochemical cells that are known as pouch cells or coffee bag cells, though the electrochemical cell of the present invention is not intended to be limited to this application.

Such an electrochemical cell usually has an electrode arrangement that is at least partially enclosed by a casing. In this context, an electrode arrangement is understood to be an arrangement including at least two electrodes and an electrolyte arranged therebetween. The electrolyte may be partially absorbed by a separator, wherein the separator then separates the electrodes. The electrode arrangement preferably includes multiple layers of electrodes and separators, each of the electrodes of the same polarity being electrically connected to one another, particularly in parallel. The electrodes are in the form of a plate or a foil, for example, and are preferably arranged essentially parallel with each other (prismatic energy storage cells). The electrode arrangement may also be in the form of a winding and have an essentially cylindrical shape (cylindrical energy storage cells). The term electrode arrangement is intended to include electrode coils of such kind as well. The electrode arrangement may contain lithium or another alkali metal, in ionic form as well.

For the purposes of this invention, a “sheet- or plate-type object” is understood to be an essentially flat object, preferably a thin, flat object. In this context, a flat object is an object whose dimensions in a direction perpendicular to its surface (also called the thickness direction) are significantly smaller than the dimensions of the largest sections that lie entirely within the surface. The first and second object side surfaces each form the faces of such a flat object, wherein the first and second object side surfaces preferably extend essentially parallel to one another, although the invention is not intended to be limited to this design variant. The one side surface that connects the first and second object side surfaces determines the thickness dimension of the flat object. In this context, the side surface preferably extends essentially perpendicularly to the first and second object side surfaces, although the invention is not intended to be limited to this design variant. The first and second object side surfaces may generally have any shape, the first and the second object side surface are preferably both essentially rectangular; in this case, the object has a total of four side faces, the adjacent side faces being arranged essentially at right angles to one another. The objects may generally have any thickness dimension, and this is preferably in the range from foil thickness to plate thickness. The first object side surface of the object may also be called the object upper side and the second object side surface of the object may also be called the object lower side, or vice versa.

The step of reducing the electrostatic charge on the first object side surface of the sheet- or plate-type objects is preferably performed in such manner that the electrostatic charge on the first object side surface is eliminated. The step of reducing the electrostatic charge on the second object side surface of the sheet- or plate-type objects is also preferably performed in such manner that the electrostatic charge on the second object side surface is eliminated. In this way, the advantages described in the preceding may be yet further enhanced.

In the step of reducing the electrostatic charge on the first object side surface in the process, the plasma is preferably applied to the first object side surface via at least one first plasma jet. Additionally, in the step of reducing the electrostatic charge on the second object side surface, the plasma is preferably applied to the second object side surface via at least one second plasma jet. One advantage of this variation consists in that the plasma may thus be applied particularly well to the object side surfaces.

In the step of reducing the electrostatic charge on the first object side surface in the process, the at least one first plasma jet is preferably operated with air and under high tension. Additionally, in the step of reducing the electrostatic charge on the second object side surface, the at least one second plasma jet is preferably operated with air and under high tension. One advantage of this variation consists in that it may be integrated particularly easily in production systems.

In the step of reducing the electrostatic charge on the first object side surface in the process, the at least one first plasma jet is preferably operated with a process gas and under high tension. Additionally, in the step of reducing the electrostatic charge on the second object side surface, the at least one second plasma jet is preferably operated with a process gas and under high tension. One advantage of this variation consists in that it thus becomes possible to subject the surfaces to further processing, and particularly to activate the surfaces.

In the step of reducing the electrostatic charge on the first object side surface in the process, the plasma preferably flows out of the at least one first plasma jet at such a high flow velocity that any particles located on the first object side surface are removed. Additionally, in the step of reducing the electrostatic charge on the second object side surface, the plasma preferably flows out of the at least one second plasma jet at such a high flow velocity that any particles located on the second object side surface are removed. One advantage of this variation consists in that cleaning the surfaces may be carried out easily.

In the step of reducing the electrostatic charge on the first object side surface in the process, when flowing out of the at least one first plasma jet the plasma preferably contains particles that are excited to such a degree that they cause the first object side surface to become activated. Additionally, in the step of reducing the electrostatic charge on the at least one second object side surface, when flowing out of the second plasma jet the plasma preferably contains particles that are excited to such a degree that they cause the second object side surface to become activated. One advantage of this variation consists in that activation of the surfaces enables the surfaces to be coated more effectively with the electrolyte. A further advantage consists in that the capacitance of the cells may be increased. Yet another advantage consists in that it thus becomes possible to shorten the time required for filling with the electrolyte. Another advantage consists in that the discharge rates may be increased. Another advantage consists in that higher current densities are made possible. Another advantage of this variation consists in that precipitation of lithium on the surface may be reduced and that the growth in thickness of the electrochemical cell towards the end of the service life thereof diminishes. Yet another advantage of this variation consists in that it is possible to achieve improved binding of the activated surfaces may be achieved during the cyclization. A further advantage of this variation consists in that a prolonged service life and greater number of cycles may be achieved. A further advantage consists in that the ability of the separators to be laminated may be increased, particularly in the case of separators having three layers.

In the step of reducing the electrostatic charge on the first object side surface in the process, the at least one first plasma jet is guided on a robot. Additionally, in the step of reducing the electrostatic charge on the second object side surface, the at least one second plasma jet is guided on a robot. One advantage of this variation consists in that it thus becomes possible to guide the plasma in such manner that the electrostatic charge may be reduced or eliminated even on surfaces of complex construction or even on electrode arrangements.

The step of reducing the electrostatic charge on the first object side surface and the step of reducing the electrostatic charge on the second object side surface in the process are preferably carried out simultaneously on the electrodes and the separators, after the electrodes and the separators have been arranged in a wound and/or stacked electrode arrangement.

In addition, in the production process for at least one component of the electrode a material may be selected from a group including: LiCoO₂, LiNiO₂, LiFePO₄, Li₄Ti₅O₁₂, Li[NiₓCo_{1-x-y}Mn_{y}]O₂, Li[NiₓCo_{1-x-y}Al_{y}]O₂, SnO₂ or LaMn₂O₄.

Preferably, a separator is used that is poorly conductive for electrons or entirely non-conductive, and which includes an at least partly substance-permeable carrier. At least one side of the carrier is preferably coated with an inorganic material. Preferably, an organic material that is preferably not in the form of a woven fleece is used as the at least partially substance-permeable carrier. The organic material, which preferably contains a polymer, and particularly preferably contains a polyethylene terephthalate (PET), is coated with an inorganic, preferably ion-conducting material that is more preferably ion-conductive in a temperature range from −40° C. to 200° C. The inorganic material preferably contains at least one compound from the group of oxides, phosphates, sulphates, titanates, silicates, aluminosilicates with at least one of the elements Zr, Al, Li, particularly preferably zirconium oxide. The inorganic, ion-conductive material preferably includes particles with a diameter not exceeding 100 nm. Such a separator is marketed in Germany under the trade name “Separion” by Evonik AG, for example.

This process is particularly suitable for continuous production processes in continuous production lines. The process is also suitable for producing a large number of objects. It thus offers particular advantages for producing electrodes or separators for making electrochemical energy stores.

According to a second aspect, this object is solved for a system for producing sheet- or plate-type objects, particularly for producing electrodes and/or separators for constructing an electrochemical energy store, preferably designed for use in a motor vehicle, or for producing parts of such electrodes and/or such separators, wherein the sheet- or plate-type objects have a first object side surface and a second object side surface on the opposite side to the first object side surface, in that the production system includes a plasma device that is configured and designed in such manner that the electrostatic charge on the first object side surface of the sheet- or plate-type objects is reduced, and preferably eliminated, by applying the plasma thereto, and that the electrostatic charge on the second object side surface of the sheet- or plate-type objects is reduced, and preferably eliminated.

In the production system, the plasma device preferably includes at least one first plasma jet for the first object side surface that is preferably guided on a robot, and in particular at least one plasma jet for the second object side surface that is preferably guided on a robot.

Regarding the advantages of this production system and the terms used, the explanations provided in the preceding with regard to the production process apply correspondingly.

The present invention also relates to an electrical cell for an electrochemical energy storage device having electrodes, and that has been produced according to a production method as described in the preceding and/or with the aid of a production system as described in the preceding.

Further advantages, features and potential uses of the present invention will be apparent from the following description in conjunction with the drawing. In the drawing:

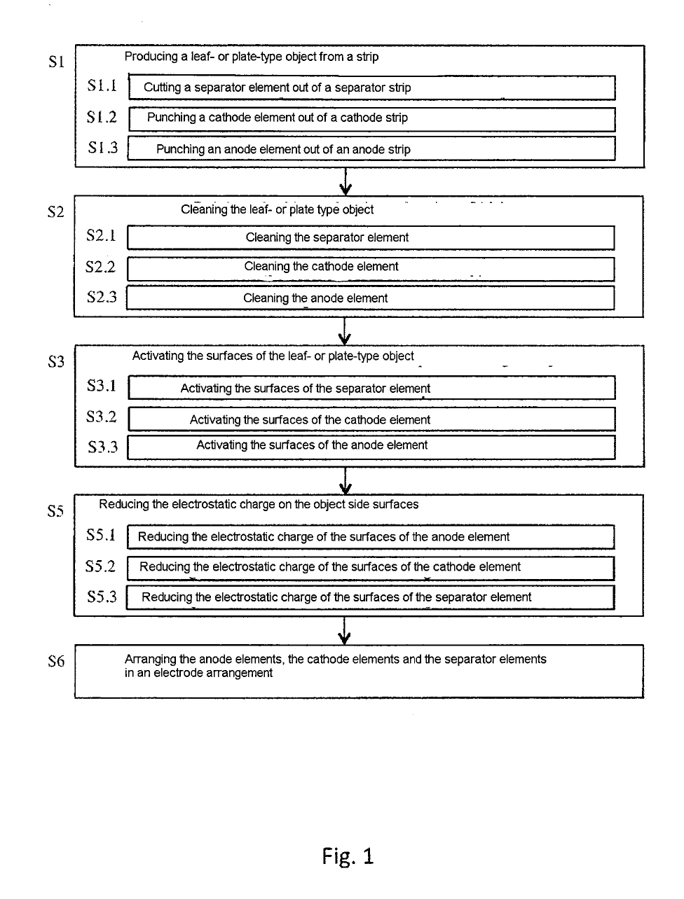

FIG. 1 is a flowchart for a manufacturing process of a first embodiment according to the present invention, and

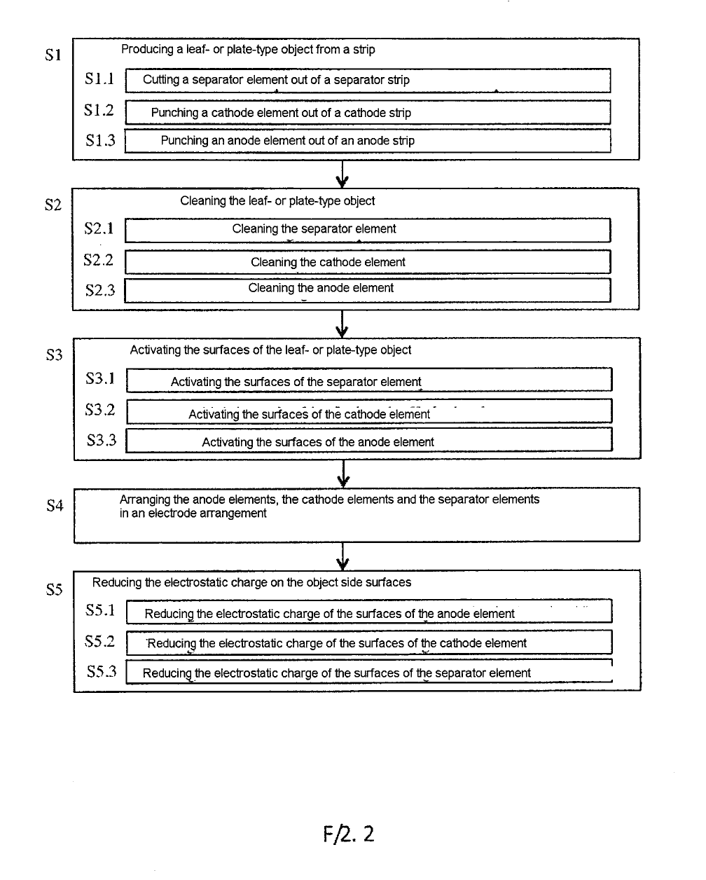

FIG. 2 is a flowchart for a manufacturing process of a second embodiment according to the present invention.

FIG. 1 shows an embodiment of a production process according to a first embodiment of the present invention, in which sheet- or plate-type objects are manufactured from a strip in a step S1 in a continuous process. As is shown in FIG. 1, this step S1 may include a step S1.1, in which separator elements are cut out of a separator strip, and a step S1.2, in which cathode element are punched out of a cathode strip, and a step S1.3, in which anode elements are punched out of an anode strip.

Afterwards, the sheet- or plate-type objects are cleaned in a step S2. As is shown in FIG. 1, this step S2 may include a substep S2.1, in which the separator elements are cleaned, and a substep S2.2, in which the cathode elements are cleaned, and a substep S2.3, in which the anode elements are cleaned. Afterwards, the surfaces of the sheet- or plate-type objects are activated in a step S3. As is shown in FIG. 1, this step S3 may include a substep S3.1, in which the surfaces of the separator elements are activated, and a substep S3.2, in which the surfaces of the cathode elements are activated, and a substep S3.3, in which the surfaces of the anode elements are activated. According to a further embodiment, not shown in this figure, step S3 and its substeps may also be carried before step S2 and the substeps thereof.

Afterwards, in a step S5 the electrostatic charge on the object side surfaces of the sheet- or plate-type objects is reduced by the effect of a plasma. Step S5 may include a substep S5′, in which the electrostatic charge on the first object side surface of the sheet- or plate-type objects is reduced by the effect of a plasma, and a substep S5″, in which the electrostatic charge on the second object side surface of the sheet- or plate-type objects is reduced by the effect of the plasma. As is shown in FIG. 1, step S5 may include a substep S5.1, in which the electrostatic charge on the surfaces of the separator elements is reduced by the effect of a plasma, and a substep S5.2, in which the electrostatic charge on the surfaces of the cathode elements is reduced by the effect of a plasma, and a substep S5.3, in which the electrostatic charge on the surfaces of the anode elements is reduced by the effect of a plasma.

Afterwards, in a step S6, the cathode elements, the anode elements and the separator elements are arranged to form an electrode arrangement, which is preferably stacked or wound.

According to a further preferred embodiment, not shown in the figure, the step S5 of reducing the electrostatic charge on the object side surfaces (including the substeps thereof) may perform a cleaning and activation of the surfaces of the cathode elements, the anode elements and the separator elements by appropriate selection of the parameters of the plasma, thereby speeding up and simplifying the processing.

The further embodiment shown in FIG. 2 is identical to the embodiment shown in FIG. 1 with regard to steps S1 to S3 and the substeps thereof, so reference is made to the corresponding sections of the description relating to FIG. 1, to avoid repeating the descriptions of these steps and substeps. In a step S4 following step S3 and the substeps thereof, the cathode elements, the anode elements and the separator elements are then arranged to form an electrode arrangement, which is preferably stacked or wound.

Afterwards, in a step S5 the electrostatic charge on the object side surfaces of the sheet- or plate-type objects is reduced by the effect of a plasma, wherein plasma jets may be guided on robots. This step S5 may also include substep S5′, in which the electrostatic charge on the first object side surface of the sheet- or plate-type objects is reduced by the effect of the plasma, and a substep S5″, in which the electrostatic charge on the second object side surface of the sheet- or plate-type objects is reduced by the effect of the plasma. As is shown in FIG. 2, this step S5 may also include substep S5.1, in which the electrostatic charge on the surfaces of the separator elements is reduced by the effect of a plasma, and a substep S5.2, in which the electrostatic charge on the surfaces of the cathode elements is reduced by the effect of a plasma, and substep S5.3, in which the electrostatic charge on the surfaces of the anode elements is reduced by the effect of a plasma.

The reduction of the electrostatic charge with a plasma prevents the occurrence of damage during production, and a further advantage may be obtained by selecting the parameters of the plasma appropriately so that the surfaces may also be cleaned and activated, thereby improving the covering with electrolyte and the service life of the elements may be prolonged. In addition, the times for filling with the electrolyte during the production of the electrochemical stores may also be shortened.

### LIST OF REFERENCE SIGNS

S1 Producing a sheet- or plate-type object from a strip
S1.1 Cutting separator element out of a separator strip
S1.2 Punching a cathode element out of a cathode strip
S1.3 Punching an anode element out of an anode strip
S2 Cleaning the sheet- or plate-type object
S2.1 Cleaning the separator element
S2.2 Cleaning the cathode element
S2.3 Cleaning the anode element
S3 Activating the surfaces of the sheet- or plate-type object
S3.1 Activating the surfaces of the separator element
S3.2 Activating the surfaces of the cathode element
S3.3 Activating the surfaces of the anode element
S4 Arranging the anode elements, the cathode elements and the separator elements to form an electrode arrangement
S5 Reducing the electrostatic charge on the object side surfaces
S5′ Reducing the electrostatic charge on the first object side surface
S5″ Reducing the electrostatic charge on the second object side surface
S5.1 Reducing the electrostatic charge of the surfaces of the separator element
S5.2 Reducing the electrostatic charge of the surfaces of the cathode element
S5.3 Reducing the electrostatic charge of the surfaces of the anode element
S6 Arranging the anode elements, the cathode elements and the separator elements to form an electrode arrangement

1. A process for producing sheet- or plate-type objects, particularly for producing electrodes and/or separators for constructing an electrochemical energy storage, preferably designed for use in a motor vehicle, or for producing parts of such electrodes and/or such separators, wherein the sheet- or plate-type objects have a first object side surface and a second object side surface on the opposite side to the first object side surface, characterised in that the production process includes the following steps:
(S5′) Reducing the electrostatic charge on the first object side surface of the sheet- or plate-type objects by applying a plasma, particularly an atmospheric plasma to act on the first object side surface of the sheet- or plate-type objects, and
(S5″) Reducing the electrostatic charge on the second object side surface of the sheet- or plate-type objects by applying a plasma, particularly an atmospheric plasma to act on the second object side surface of the sheet- or plate-type objects.

2. The process according to claim 1, characterised in that the step (S5′) of reducing the electrostatic charge on the first object side surface of the sheet- or plate-type objects is carried out in such manner that the electrostatic charge on the first object side surface is eliminated, and/or that the step (S5″) of reducing the electrostatic charge on the second object side surface of the sheet- or plate-type objects is carried out in such manner that the electrostatic charge on the second object side surface is eliminated.

3. The process according to claim 1 or 2, characterised in that in the step (S5′) of reducing the electrostatic charge on the first object side surface the plasma is applied to the first object side surface via at least one first plasma jet and/or that in step (S5″) of reducing the electrostatic charge on the second object side surface the plasma is applied to the second object side surface via at least one second plasma jet.

4. The process according to claim 3, characterised in that in the step (S5′) of reducing the electrostatic charge on the first object side surface the at least one first plasma jet is operated with air and under high tension, and/or that in the step (S5″) of reducing the electrostatic charge on the second object side surface the at least one second plasma jet is operated with air and under high tension.

5. The process according to claim 3, characterised in that in the step (S5′) of reducing the electrostatic charge on the first object side surface the at least one first plasma jet is operated with a process gas and under high tension, and/or that in the step (S5″) of reducing the electrostatic charge on the second object side surface the at least one second plasma jet is operated with a process gas and under high tension.

6. The process according to any of claims 3 to 5, characterised in that in the step (S5′) of reducing the electrostatic charge on the first object side surface the plasma flows out of the at least one first plasma jet at such a high flow velocity that any particles located on the first object side surface are removed, and/or that in the step (S5″) of reducing the electrostatic charge on the second object side surface the plasma flows out of the at least one second plasma jet at such a high flow velocity that any particles located on the second object side surface are removed.

7. The process according to any of claims 3 to 6, characterised in that in the step (S5′) of reducing the electrostatic charge on the first object side when flowing out of the at least one first plasma jet the plasma contains particles that are excited to such a degree that they cause the first object side surface to become activated and/or that in the step (S5″) of reducing the electrostatic charge on the at least one second object side surface when flowing out of the second plasma jet the plasma contains particles that are excited to such a degree that they cause the second object side surface to become activated.

8. The process according to any of claims 3 to 7, characterised in that in the step (S5′) of reducing the electrostatic charge on the first object side surface the at least one first plasma jet is guided on a robot, and/or that in the step (S5″) of reducing the electrostatic charge on the second object side surface the at least one second plasma jet is guided on a robot.

9. The process according to claim 8, characterised in that the step (S5′) of reducing the electrostatic charge on the first object side surface and the step (S5″) of reducing the electrostatic charge on the second object side surface are carried out on the electrodes and the separators simultaneously, after the electrodes and the separator have been arranged to form a wound and/or stacked electrode arrangement.

10. The process according to any of claims 1 to 9, characterised in that for at least one component of the electrode a material is selected from a group consisting of: LiCoO₂, LiNiO₂, LiFePO₄, Li₄Ti₅O₁₂, Li[NiₓCo_{1-x-y}Mn_{y}]O₂, LiNi₁₋ₓCoₓO₂, Li[NiₓCo_{1-x-y}Al_{y}]O₂, SnO₂ or LaMn₂O₄.

11. The process according to any of claims 1 to 10, characterised in that for at least one component of the separator a material is selected that conducts ions poorly or not at all, and which is made at least in part from a substance-permeable carrier, wherein at least one side of the carrier is preferably coated with an inorganic material, wherein an organic material that is preferably not in the form of a woven fleece is preferably used as the at least partially substance-permeable carrier, wherein the organic material preferably contains a polymer and particularly preferably a polyethylene terephthalate (PET), wherein the organic material is coated with an inorganic, preferably ion-conducting material, which more preferably is conductive of ions in a temperature range from −40° C. to 200° C., wherein the inorganic material preferably contains at least one compound from the group of oxides, phosphates, sulphates, titanates, silicates, aluminosilicates, at least one of the elements Zr, Al, Li, particularly preferably zirconium oxide, and wherein the inorganic, ion-conductive material preferably includes particles with a largest diameter smaller than 100 nm.

12. A system for producing sheet- or plate-type objects, particularly for producing electrodes and/or separators for constructing an electrochemical energy storage, preferably designed for use in a motor vehicle, or for producing parts of such electrodes and/or such separators, wherein the sheet- or plate-type objects have a first object side surface and a second object side surface on the opposite side to the first object side surface, characterised in that the production system includes a plasma device that is configured and designed in such manner that the electrostatic charge on the first object side surface of the sheet- or plate-type objects is reduced, and preferably eliminated, by applying the plasma thereto, and that the electrostatic charge on the second object side surface of the sheet- or plate-type objects is reduced, and preferably eliminated.

13. The production system according to claim 12, characterised in that the plasma device has at least a first plasma jet, preferably guided on a robot, for the first object side surface, and particularly at least one second plasma jet, preferably guided on a robot, for the second object side surface.
